(19) United States
(12) Patent Application Publication
(10) Pub. No.: US 2026/0031268 A1
(43) Pub. Date: Jan. 29, 2026

(54) ARRAY-TYPE INDUCTOR

(71) Applicant: TAIYO YUDEN CO., LTD., Tokyo (JP)

(72) Inventors: Takayuki ARAI, Tokyo (JP); Tomoo KASHIWA, Tokyo (JP)

(21) Appl. No.: 19/268,152

(22) Filed: Jul. 14, 2025

(30) Foreign Application Priority Data
Jul. 25, 2024 (JP) 2024-119656

(51) Int. Cl. H01F 27/29; H01F 27/06

(52) U.S. Cl. CPC H01F 27/292; H01F 27/06

(57) ABSTRACT

An array-type inductor includes a plurality of inductor elements provided in a base body made of a metallic magnetic material, wherein each of the plurality of inductor elements includes a conductor and an external electrode connected to the conductor, the external electrodes of the plurality of inductor elements are arranged on one surface of the base body so as to be separated from each other, each of the external electrodes has a first portion arranged on an outermost side thereof and a second portion connecting the first portion and the conductor, an insulating layer is arranged between the second portions, with respect to the inductor elements that are adjacent to each other, d1<d2<dc is satisfied, d1 denoting a distance between the first portions, d2 denoting a distance between the second portions, and dc denoting a distance between the conductors on the one surface.

### CROSS-REFERENCE TO RELATED APPLICATIONS

This patent application is based on and claims priority to Japanese Patent Application No. 2024-119656 filed on Jul. 25, 2024, the entire contents of which are incorporated herein by reference.

### TECHNICAL FIELD

The present disclosure relates to an array-type inductor having a plurality of inductor elements and used for being embedded in a substrate.

### BACKGROUND

As a coil component, an array-type inductor having two or more inductor elements in a base body made of a magnetic material is known. In the array-type inductor, a plurality of inductors are packaged into one component. An array-type inductor includes a base body, a plurality of conductors provided in the base body and separated and insulated from each other in the base body, and a plurality of external electrodes provided on the surface of the substrate. Each external electrode is connected to the end of one of the conductors. Conventional array-type inductors are described, for example, in Patent Documents 1 and 2.

Further, a component-embedded substrate in which electronic components such as coil components are embedded in the substrate is known. By embedding a plurality of coil components in the substrate, electronic components such as coil components can be mounted at high density.

In the component-embedded substrate, external electrodes of electronic components such as coil components are electrically connected to the wiring through via conductors. The via conductors are formed by sealing, with resin, a coil component mounted in a cavity formed in an insulating layer of a printed circuit board, radiating a laser toward the external electrode of the coil component sealed with the resin to form a via hole, exposing the external electrode, and applying plating treatment to the via hole.

### RELATED ART DOCUMENT

### Patent Document

Patent Document 1: Japanese Laid-open Patent Application Publication No. 2019-153649
Patent Document 2: Japanese Laid-open Patent Application Publication No. 2006-032424

### SUMMARY

An embodiment of the present disclosure is an array-type inductor includes a plurality of inductor elements provided in a base body made of a metallic magnetic material, wherein each of the plurality of inductor elements includes a conductor and an external electrode connected to the conductor, the external electrodes of the plurality of inductor elements are arranged on one surface of the base body so as to be separated from each other, each of the external electrodes has a first portion arranged on an outermost side thereof and a second portion connecting the first portion and the conductor, an insulating layer is arranged between the second portions, with respect to the inductor elements that are adjacent to each other, d1<d2<dc is satisfied, d1 denoting a distance between the first portions, d2 denoting a distance between the second portions, and dc denoting a distance between the conductors on the one surface.

### BRIEF DESCRIPTION OF THE DRAWINGS

FIG. 1 is a perspective view of an array-type inductor according to an embodiment of the present disclosure;

FIG. 2 is a partial enlarged view of a cross-section cut along a line I-I of FIG. 1;

FIG. 3 is a cross-sectional view cut along a line II-II of FIG. 2;

FIG. 4 is an enlarged view of part III of FIG. 2;

FIG. 5 is a cross-sectional view cut along the thickness direction of a component-embedded substrate including an array-type inductor;

FIGS. 6A to 6F are diagrams for explaining a method of manufacturing an array-type inductor according to an embodiment; and

FIGS. 7A to 7C are diagrams for explaining a method of manufacturing an array-type inductor according to an embodiment.

### DETAILED DESCRIPTION

In recent years, miniaturization of array-type inductors has been required as electronic devices become more multifunctional. In order to miniaturize array-type inductors, it is necessary to reduce the pitch between inductor elements, that is, to densely arrange a plurality of inductor elements. In addition to this, power saving of electronic devices is also required. Therefore, in particular, when an array-type inductor is incorporated in a substrate, consideration is given to reduce power distribution loss by shortening the wiring length. To shorten the wiring length, it is effective to increase the area of the external electrodes and increase the degree of freedom of the connected wiring.

However, if the area of the external electrodes is increased when a plurality of inductor elements are densely arranged, the external electrodes arranged side by side on one surface of the base body become too close to each other, and the risk of dielectric breakdown increases. In particular, when a base body composed of metal magnetic material particles made of soft magnetic material is used, magnetic saturation is less likely to occur than a base body composed of ferrite. In the base body using a metal magnetic material, insulation between conductors and external electrodes is ensured by covering the surface of the metal magnetic particles with an insulating film. Because a base body using a metal magnetic material has lower insulation than a base body consisting of ferrite, short-circuit failure tends to occur in an array-type inductor having a base body using a metal magnetic material. Therefore, it has been difficult to obtain an array-type inductor having a plurality of inductor elements densely arranged and a large area of external electrodes.

According to an embodiment of the present disclosure, it is possible to provide an array-type inductor having a plurality of inductor elements densely arranged and a reduced risk of dielectric breakdown.

Specific embodiments of the present disclosure will be described in detail below, but the present disclosure is not limited to such embodiments. In the present specification and the drawings, components having substantially the same functional configuration may be denoted by the same reference numerals and thus duplicate descriptions may be omitted. Each of the drawings is a schematic diagram illustrated for the purpose of clarifying the description of the present disclosure, and is not necessarily illustrated on an accurate scale. In the drawings, mutually orthogonal X, Y, and Z axes are illustrated as axes defining a fixed coordinate system for the array-type inductor. In this specification, the extending direction of the X-axis is referred to as the X-direction, the extending direction of the Y-axis is referred to as the Y-direction, and the extending direction of the Z-axis is referred to as the Z-direction.

### <Basic Structure of Array-Type Inductor>

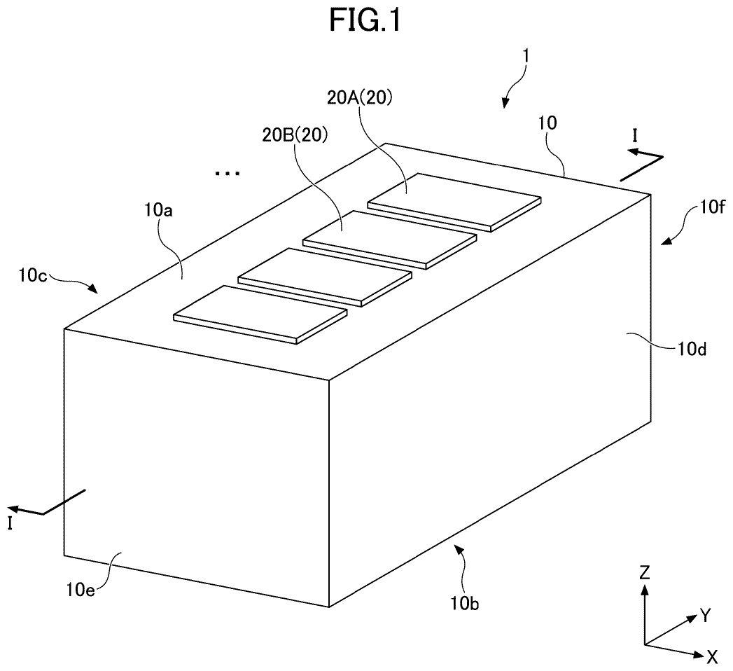

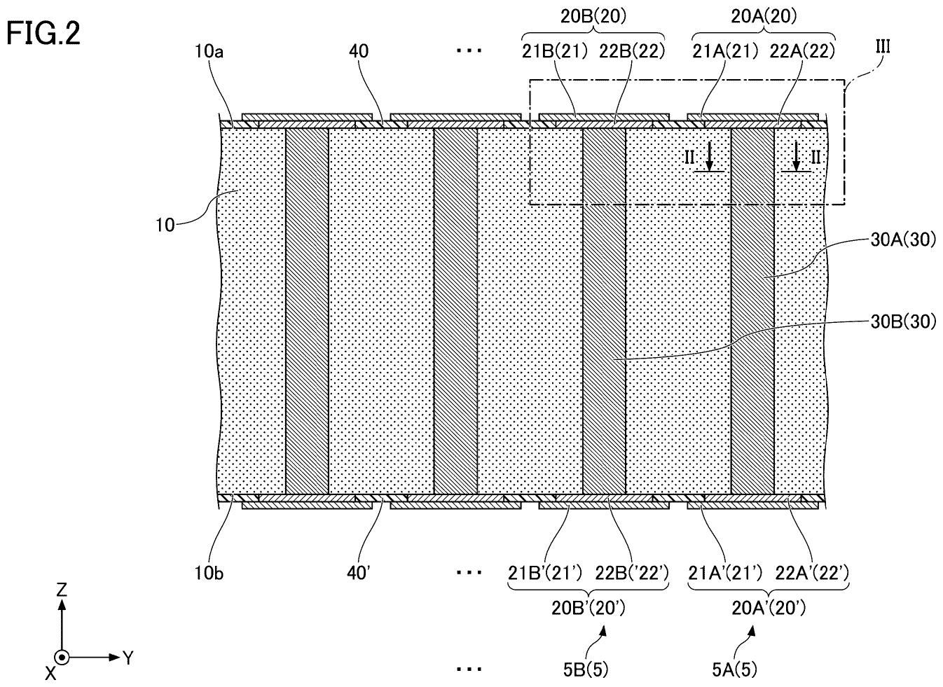

First, the basic structure of the array-type inductor 1 according to the present disclosure will be described. FIG. 1 is a perspective view of an array-type inductor 1 according to an embodiment of the present disclosure. FIG. 2 is a partial enlarged view of a cross-section cut along a line I-I in FIG. 1. FIG. 3 is a cross-sectional view along a line II-II in FIG. 2.

As illustrated in FIG. 2, the array-type inductor 1 includes a plurality of inductor elements 5A, 5B, . . . in a base body 10. In FIG. 2, only the right two inductor elements 5A, 5B are individually denoted by reference numerals, and the individual reference numerals for the other inductor elements are omitted. Further, when the plurality of inductor elements 5A, 5B, . . . included in the array-type inductor 1 are collectively referred to without distinction, they are simply referred to as inductor elements 5.

Each inductor element 5 may be, for example, an inductor element, a transformer, a filter such as a common-mode choke coil, a capacitor, a resistor, etc. The plurality of inductor elements 5 may be all the same or different. Therefore, for example, the plurality of inductor elements may be all inductor elements to constitute an array-type or combination-type inductor component.

The array-type inductor 1 is suitably used in a component-embedded wiring board, but may be used in a component-mounted wiring board. The wiring board on which the array-type inductor 1 is mounted is used in electronic devices such as smartphones, tablets, game consoles, servers, and electric components of automobiles.

In the example illustrated in FIG. 2, the plurality of inductor elements 5 included in one array-type inductor 1 all have the same configuration, but the plurality of inductor elements 5 may have different configurations. For example, the thickness, shape, and arrangement of the conductors, and the shape, size, and arrangement of the external electrodes may be different among the inductor elements 5.

In the example illustrated in FIG. 2, the number of inductor elements 5 in the array-type inductor 1 is four, but the number of inductor elements 5 is not limited to four. That is, the array-type inductor 1 may include a plurality of inductor elements 5 other than four. By including the plurality of inductor elements 5 in one array-type inductor 1, the plurality of inductor elements 5 can be densely arranged, thereby contributing to the miniaturization of the electronic device on which the array-type inductor 1 is mounted. Further, because the plurality of inductor elements 5 can be mounted simultaneously by one operation of mounting elements in one array-type inductor 1, this is preferable in that the mounting operation is not complicated. Further, because the relative position adjustment of the plurality of inductor elements 5 is not required, the reliability of the wiring board in which the array-type inductor 1 is mounted and embedded, and the electronic device in which the wiring board is mounted, can be improved.

In the example illustrated in FIG. 2, the four inductor elements 5 are arranged in a row in the Y-direction, but the plurality of inductor elements 5 may be arranged two-dimensionally. That is, a plurality of rows of inductor elements 5 arranged in one direction may be arranged in a direction orthogonal to the one direction. For example, a plurality of rows, each including inductor elements 5 arranged in the Y-direction, may be arranged in the X-direction.

As illustrated in FIG. 1, the base body 10 of the array-type inductor 1 may have a substantially rectangular parallelepiped shape. The base body 10 may have six surfaces defining its outer surface, specifically, a first main surface 10a, a second main surface 10b, a first side surface 10c, a second side surface 10d, a first end surface 10e, and a second end surface 10f. The first main surface 10a and the second main surface 10b face each other, the first side surface 10c and the second side surface 10d face each other, and the first end surface 10e and the second end surface 10f face each other. The area of each of the first main surface 10a and the second main surface 10b are larger than the area of any of the first side surface 10c, the second side surface 10d, the first end surface 10e, and the second end surface 10f. When the array-type inductor 1 is provided in a substrate to constitute a wiring board, the array-type inductor 1 is arranged such that the plane direction along the first main surface 10a or the second main surface 10b (the direction along the X-Y plane) is along the plane direction of the substrate.

As illustrated in FIGS. 1 and 2, the direction in which the first main surface 10a and the second main surface 10b face each other (opposing direction of the main surfaces 10a, 10b) is the Z-direction. The direction in which the first side surface 10c and the second side surface 10d face each other (opposing direction of the side surfaces 10c, 10d) is the X-direction, and the direction in which the first end surface 10e and the second end surface 10f face each other (opposing direction of the end surfaces 10e, 10f) is the Y-direction. In FIGS. 1 and 2, because the first main surface 10a is located on the upper side of the base body 10, the first main surface 10a may be referred to as the “upper surface” and the second main surface 10b may be referred to as the “lower surface”. The vertical direction of the base body 10 is also referred to as the height direction and is referred to as the Z-direction in the drawing. The longitudinal direction of the base body 10 is also referred to as the length direction and is referred to as the Y-direction in the drawing. Further, the direction orthogonal to both the height direction (Z-direction) and the length direction (Y-direction) is also referred to as the width direction and is referred to as the X-direction in the drawing.

In FIG. 1, each surface 10a to 10f of the base body 10 is illustrated as a plane, but each surface 10a to 10f may be curved. Although each surface 10a to 10f is illustrated to be orthogonal to the adjacent surface, each surface 10a to 10f may not necessarily be orthogonal to the adjacent surface. Further, each vertex of the base body 10 may be rounded, and the ridge line of the base body 10 (the line indicating the boundary between the adjacent surfaces of the surfaces 10a to 10f) may not be straight, but may be curved according to the shape and arrangement of each surface 10a to 10f.

The height of the base body 10, that is, the distance between the first main surface 10a and the second main surface 10b facing each other (dimension in the Z-direction) may be 0.5 mm or more and 2 mm or less. The width of the base body 10, that is, the distance between the first side surface 10c and the second side surface 10d facing each other (dimension in the X-direction) may be 0.5 mm or more and 10 mm or less. The length of the base body 10, that is, the distance between the first end surface 10e and the second end surface 10f facing each other (dimension in the Y-direction) may be 2 mm or more and 20 mm or less. The Z-direction dimension of the base body 10 may be smaller than the X-direction dimension and the Y-direction dimension. The dimension of the array-type inductor 1 is a dimension in which external electrodes 20 and 20′ and, in some cases, insulating layers 40 and 40′, are added to the base body 10, and is approximately equal to the dimension of the base body 10 described above.

The base body 10 may be made of a metallic magnetic material, and preferably includes metallic magnetic particles. The base body 10 may be a composite magnetic material containing metallic magnetic particles and a binder, that is, the base body 10 may be made of a metal composite. The base body 10 made of a metallic composite is obtained, for example, by pressure-molding a slurry obtained by kneading a composite magnetic material containing metallic magnetic particles and a binder made of resin (also referred to as a resin binder).

When the base body 10 is made of a metallic magnetic material, it is known that dielectric breakdown is relatively easy to occur. However, even in such a case, it is possible to obtain a configuration in which the inductor elements 5 are densely arranged while reducing the risk of dielectric breakdown by the arrangement of the external electrode 20 and the conductor 30 according to this embodiment.

The metal magnetic particles contained in the base body 10 may be a mixture of one or more kinds of metal magnetic particles. The metal magnetic particles contained in the base body 10 may contain one or more of iron (Fe), nickel (Ni), and cobalt (Co). Specific examples of the materials constituting the metal particles include Fe, Fe—Ni alloy, Fe—Co alloy, Fe—Si alloy, Fe—Si—Al alloy, Fe—Si—Cr alloy, Fe—Si—Al—Cr alloy, Fe—Si—Cr—B alloy, Fe—Si—Cr—B—C, and the like. These metallic magnetic particles can be used alone or as mixed particles by mixing two or more kinds.

The binder contained in the base body 10 may be an organic binder, an inorganic binder, or both. The organic binder is preferably a resin, particularly a thermosetting resin having excellent insulating properties. Specific examples of resin materials for the binder include epoxy resin, polyimide resin, polystyrene (PS) resin, high-density polyethylene (HDPE) resin, polyoxymethylene (POM) resin, polycarbonate (PC) resin, polyvinylidene fluoride (PVDF) resin, phenol resin, polytetrafluoroethylene (PTFE) resin, and polybenzoxazole (PBO) resin. Examples of the inorganic binder are inorganic oxides such as B₂O₃, NaO, SiO₂, ZnO, PbO, and glass. The above binder can be used alone or in a combination of two or more kinds.

The ratio of metallic magnetic particles to the whole base body 10 may be 80 vol % or more. The ratio of the binder to the whole base body 10 may be 3 vol % or more. The base body 10 may contain voids, but the ratio of voids to the whole base body 10 may be less than 2 vol %.

The inductor element 5A includes a conductor 30A and one external electrode 20A and the other external electrode 20A′ respectively connected to the conductor 30A. Similarly, the inductor element 5B includes a conductor 30B and one external electrode 20B and the other external electrode 20B′ respectively connected to the conductor 30B. The remaining two inductor elements have the same configuration. Here, when the conductors 30A, 30B, and . . . are collectively referred to without distinction, they may be simply referred to as the conductor 30. Also, when one external electrode 20A, 20B, . . . is collectively referred to without distinction, it may be simply referred to as the external electrode 20, and when the other external electrode 20A′, 20B′, . . . is collectively referred to without distinction, it may be simply referred to as the external electrode 20′.

As illustrated in FIG. 2, an insulating layer 40 is arranged on the first main surface 10a of the base body 10 on which the external electrodes 20A, 20B, . . . are arranged side by side. This insulating layer 40 is not illustrated in FIG. 1.

In the example illustrated in FIG. 2, one external electrode 20 is provided on the first main surface 10a of the base body 10, and the other external electrode 20′ is provided on the second main surface 10b of the base body 10. Therefore, one external electrode 20 and the other external electrode 20′ face each other in the opposing direction of the main surfaces 10a, 10b, that is, in the Z-direction. As illustrated in FIG. 2, one external electrode 20 is connected to one end of the conductor 30, and the other external electrode 20′ is connected to the other end of the conductor 30.

The external electrodes 20, 20′ may contain silver (Ag), copper (Cu), nickel (Ni), and an alloy of one or more of these components.

As illustrated in FIG. 2, one external electrode 20 has a first portion 21 arranged on the outermost side and a second portion 22 connecting the first portion 21 and the conductor 30. The other external electrode 20′ similarly has a first portion 21′ arranged on the outermost side and a second portion 22′ connecting the first portion 21′ and the conductor 30. The configuration of this external electrode consisting of a plurality of layers will be described later.

The conductor 30 is embedded in the base body 10 as illustrated in FIG. 2, and is arranged such that the two ends thereof are respectively exposed from the first main surface 10a and the second main surface 10b of the base body 10. The two ends of the exposed conductor 30 are respectively connected to the one external electrode 20 and the other external electrode 20′.

The arrangement of the conductor 30 in the base body 10 is not particularly limited. The conductor 30 may include a curved portion or a wound portion in the base body 10. Preferably, however, the conductor 30 is arranged so as to be directed from one external electrode 20 arranged on the first main surface 10a toward the other external electrode 20′ arranged on the second main surface 10b, or the conductor 30 is arranged so as to be directed from the other external electrode 20′ arranged on the second main surface 10b toward the one external electrode 20 arranged on the first main surface 10a. That is, the conductor 30 may extend along the opposing direction in which the first main surface 10a and the second main surface 10b face each other, that is, the Z-direction. More preferably, the conductor may be partially or entirely linearly arranged in the base body 10. When the conductor 30 and the conductor 30 are linearly arranged partially, preferably entirely, as illustrated in FIG. 2, the conductors 30 can be arranged closer to each other, and the plurality of inductor elements 5 can be arranged more densely, thus contributing to the miniaturization of the array-type inductor 1 and is preferable.

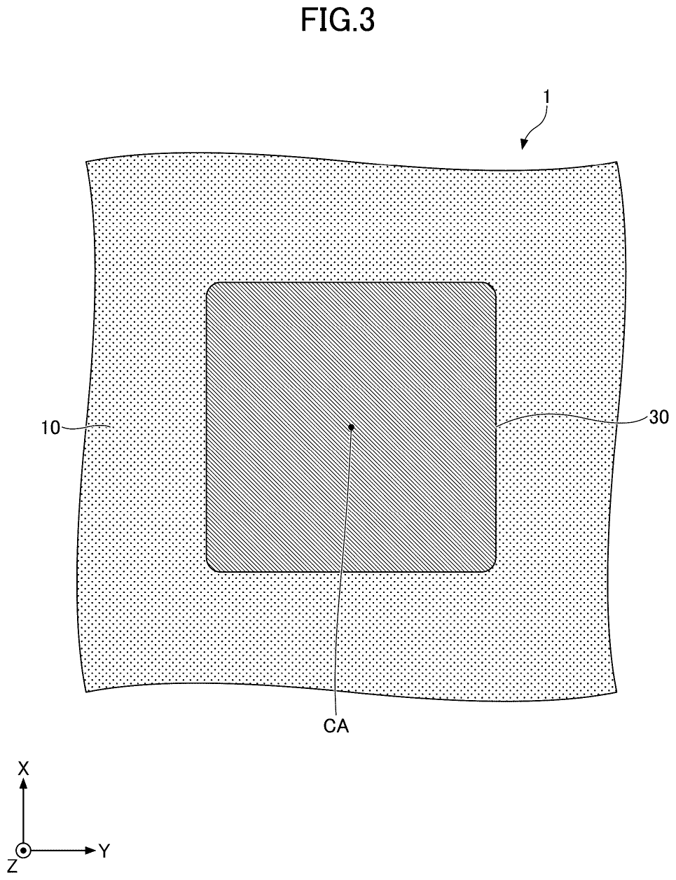

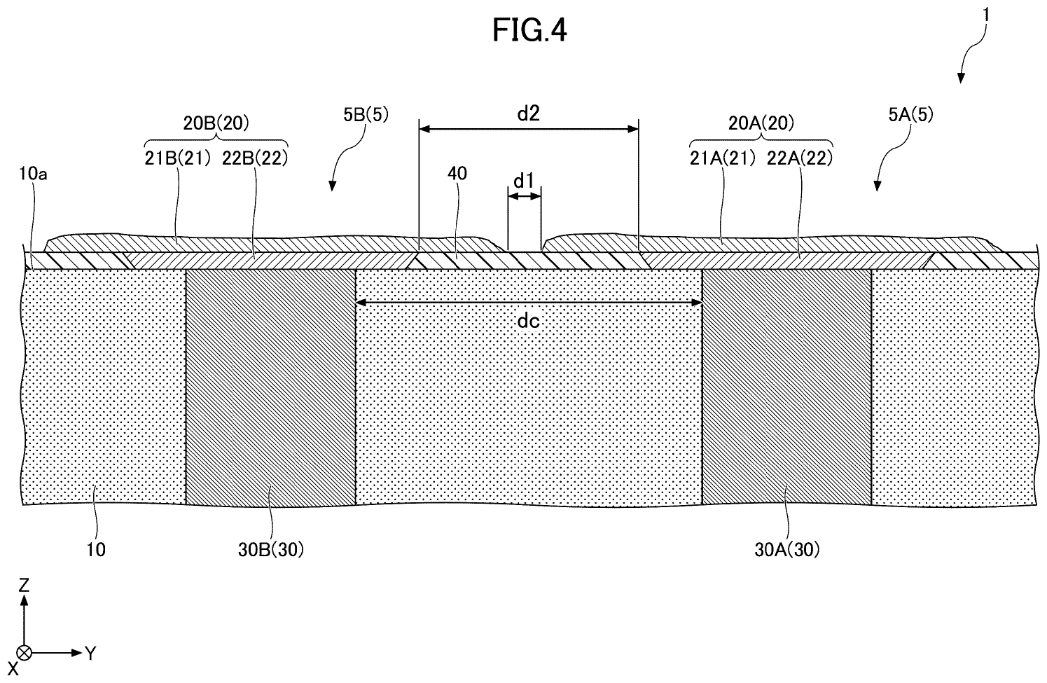

In this specification, the term “along a predetermined direction” encompasses both exact alignment with the predetermined direction and slight deviation from it. Such deviations are defined as forming an angle of preferably 10° or less, more preferably 5° or less relative to the predetermined direction. The “linear” arrangement of the conductor 30 means that the center axis CA (FIG. 4) of the conductor 30 is arranged along the opposing direction (Z-direction) in which the first main surface 10a and the second main surface 10b face each other, and preferably, the direction of the center axis CA (FIG. 4) of the conductor is arranged so as to be in exact alignment with the opposing direction (Z-direction).

The cross-sectional shape of the conductor 30, that is, the cross-sectional shape cut in the direction orthogonal to the Z-direction (the cross-sectional shape cut along the X-Y plane), is not particularly limited, and may be a polygon such as a square, a triangle, or a pentagon, a circle, or an ellipse. When the cross-sectional shape has vertices, the vertices may be rounded. As illustrated in FIG. 3, the cross-sectional shape of the conductor may be a substantially square in which each vertex of the square is rounded.

The conductor 30 may contain silver (Ag), copper (Cu), nickel (Ni), and an alloy of one or more of these. The conductor 30 may be formed by providing a conductor forming material (conductive paste, etc.) by plating, screen printing, etc.

### <Arrangement of Inductor Elements Between Each Other>

FIG. 4 is an enlarged view of a part III of FIG. 2. FIG. 4 illustrates adjacent inductor elements 5A and 5B of the plurality of inductor elements on the first main surface 10a side of the base body 10.

In response to the demand for miniaturization of components in recent years, it is preferable that the plurality of inductor elements 5 are arranged as densely as possible in the base body 10. Further, in order to reduce power consumption, it is required that high-density wiring can be mounted with high accuracy in the array-type inductor 1. For this purpose, it is considered to increase the degree of freedom of wiring by increasing the area of the external electrode 20. However, in an array-type inductor in which inductor elements are densely arranged, if the area of the external electrode is increased, the external electrodes arranged side by side on one surface of the base body become too close to each other. As a result, the risk of dielectric breakdown increases, and the reliability of the array-type inductor may be impaired.

On the other hand, in this embodiment, each of the external electrodes 20 is composed of a plurality of portions. In the example illustrated in FIG. 4, the external electrode 20 has a first portion 21 arranged on the outermost side and a second portion 22 connecting the first portion 21 and the conductor 30. More specifically, the external electrode 20A has an outermost first portion 21A and a second portion 22A located on an inner side than the first portion 21A. Similarly, the external electrode 20B has an outermost first portion 21B and a second portion 22B located on an inner side than the first portion 21B.

Because the external electrode 20 is composed of a plurality of layers, each layer can have a different function, thereby improving the function of the external electrode 20.

As described above, the external electrode 20 may contain silver (Ag), copper (Cu), nickel (Ni), and an alloy of one or more of these components, and each of the first portion 21 and the second portion 22 may contain the above-mentioned components. The first portion 21 and the second portion 22 may be composed of the same material or different materials.

Further, at adjacent inductor elements 5, a distance d2 between the second portions 22 is longer than a distance d1 between the first portions 21. That is, d1<d2 is satisfied. In the example illustrated in FIG. 4, with regard to the adjacent inductor elements 5A and 5B, the distance d2 between the second portion 22A of the external electrode 20A and the second portion 22B of the external electrode 20B is longer than the distance d1 between the first portion 21A of the external electrode 20A and the first portion 21B of the external electrode 20B.

By setting d1<d2, the distance between the external electrodes 20 on the base body 10 side can be increased while maintaining the size of the area of the outermost portion of the external electrode 20 that is exposed to the outside. When the above-described dielectric breakdown occurs between the external electrodes 20, it is likely to occur on the side of the external electrodes 20 closer to the conductor 30. More specifically, the dielectric breakdown between the external electrodes 20 is likely to occur on the surface of the base body 10 (the first main surface 10a in the example illustrated in FIG. 4). Therefore, the dielectric breakdown can be effectively prevented by widening the interval between the second portions 22 of the external electrodes 20, that is, widening the interval between the portions of the external electrode 20 closer to the base body 10. Further, by narrowing the interval between the first portions 21 of the external electrode 20 that are exposed to the outside, as the area of the portion where the wiring is installed, a large area can be ensured at the time of mounting the array-type inductor 1. Therefore, the degree of freedom of the wiring can be increased at the time of mounting the array-type inductor 1, and highly accurate and high-density wiring can be obtained, and the above-described power saving and the like can be realized.

Further, in each inductor element 5, it is preferable to make the area of the first portion 21 larger than the area of the second portion 22 in a plan view. Thus, the relation of d1<d2 can be obtained more reliably.

In this specification, “plan view” means that the external electrode is viewed in a direction toward one surface of the base body 10 on which the external electrode 20 is provided, and in the example illustrated in FIG. 4, it means a direction toward the first main surface 10a of the base body 10.

In each inductor element 5, it is preferable that the second portion 22 is provided within the confines of the first portion 21 in a plan view. Even with this configuration, the relation of d1<d2 can be obtained more reliably.

Further, for the adjacent inductor elements 5, the distance d2 between the second portions 22 is shorter than the distance de between the conductors 30 on one surface. That is, d2<dc is satisfied. In the example illustrated in FIG. 4, for the adjacent inductor elements 5A and 5B, the distance d2 between the second portion 22A of the external electrode 20A and the second portion 22B of the external electrode 20B is shorter than the distance de between the conductors 30A and 30B on the first main surface 10a of the base body 10.

By setting d2<dc, the risk of dielectric breakdown occurring between the conductors 30 can be reduced, and the distance between the conductors 30 can be made shorter. Accordingly, the inductor elements 5 can be densely arranged in the base body 10, and the array-type inductor 1 with smaller size and higher performance can be obtained. Further, as illustrated in FIGS. 2 and 4, dielectric breakdown between the conductors can be reduced even if the conductors 30 do not have a winding portion but extend linearly and the conductors 30 are arranged closer to each other than in the winding type conductors.

Further, in each inductor element 5, it is preferable that the area of the second portion 22 is larger than the area of the conductor 30 in a plan view. As a result, the relationship of d2<dc can be obtained more reliably.

In each inductor element 5, it is preferable that the conductor 30 is provided within the confines of the second portion 22 in a plan view. Even with this configuration, the relationship of d2<dc can be obtained more reliably.

Further, d1<dc is satisfied. That is, the distance d1 between the first portions 21 of the adjacent inductor elements 5 is shorter than the distance dc between the conductors 30 on one surface. In the example illustrated in FIG. 4, the distance d1 between the first portion 21A of the external electrode 20A and the first portion 21B of the external electrode 20B of the adjacent inductor elements 5A and 5B is shorter than the distance dc between the conductors 30A and 30B on the first main surface 10a of the base body 10.

Because d1<dc is satisfied, as the area of the portion exposed to the outside of the external electrode 20, a large area can be ensured, to increase the degree of freedom of wiring when the array-type inductor 1 is mounted, and the risk of dielectric breakdown occurring between the conductors 30 can be reduced. This enables the distance between the conductors 30 to be closer, and thus the inductor elements 5 can be densely arranged in the base body 10.

Further, in each inductor element 5, it is preferable that the area of the first portion 21 is larger than the area of the conductors 30 in a plan view. Thus, the relationship of d1<dc can be obtained more reliably.

In each inductor element 5, it is preferable that the conductor 30 is provided within the confines of the first portion 21 in a plan view. Even with this configuration, the relationship of d1<dc can be obtained more reliably.

As described above, in the present embodiment, for the adjacent inductor elements 5, given that the distance between the first portions 21 is d1, the distance between the second portions 22 is d2, and the distance between the conductors 30 on one surface on which the external electrode is arranged is dc, d1<d2<dc is satisfied. Accordingly, in the array-type inductor 1 in which a plurality of inductor elements 5 are provided close to each other, it is possible to ensure a sufficiently large area on the external electrodes 20 to ensure a high degree of freedom of wiring at the time of mounting, and to reduce the risk of dielectric breakdown. According to the present embodiment, even when the base body 10 is made of a metallic magnetic material that is prone to dielectric breakdown, the effect of reducing dielectric breakdown is sufficiently demonstrated.

Further, the value of the ratio of the distance d2 between the second portions 22 to the distance d1 between the first portions 21 (d2/d1) may preferably be 5 or more and 25 or less, and more preferably 10 or more and 20 or less. When d2/d1 is in the above range, it is possible to reduce the risk of dielectric breakdown between the second portions 22 that are adjacent to each other, and consequently, the dielectric breakdown of the entire external electrode 20. Further, it is possible to ensure sufficient area of the first portion 21, increase the degree of freedom of wiring at the time of mounting, and improve the effect that dense wiring is possible.

The value of the ratio of the distance dc between the conductors 30 to the distance d1 between the first portions (dc/d1) may be 2 or more, preferably 10 or more, and more preferably 20 or more. When dc/d1 is in the above range, it is possible to reduce the risk of dielectric breakdown between the conductors 30 in the base body 10. From the viewpoint of miniaturizing the array-type inductor 1 by densely arranging the inductor elements 5 in the base body 10, dc/d1 may preferably be 40 or less, and more preferably 30 or less.

The overall thickness (length in Z-direction) of the external electrode 20 may preferably be 8 μm or more and 50 μm or less, more preferably 15 μm or more and 35 μm or less. When the external electrode includes the first portion 21 and the second portion 22, the thickness of the external electrode 20 may be the sum of the thickness of the first portion 21 and the thickness of the second portion 22.

The thickness of the first portion 21 may preferably be 3 μm or more and 20 μm or less, more preferably 5 μm or more and 15 μm or less. The thickness of the second portion 22 may preferably be 5 μm or more and 30 μm or less, more preferably 10 μm or more and 20 μm or less.

The thickness of the first portion 21 of the external electrode 20 may be greater than or less than the thickness of the second portion 22. However, if the thickness (t2) of the second portion 22 of the external electrode 20 is greater than the thickness (t1) of the first portion 21 (t2>t1), it is preferable, because the electrical characteristics of the connection portion between the second portion 22 and the conductor 30 can be ensured and stable connection can be obtained. The value of the ratio (t1/t2) of the thickness (t1) of the first portion 21 to the thickness (t2) of the second portion 22 may preferably be 0.1 or more and less than 1, more preferably 0.25 or more and 0.8 or less.

Further, as illustrated in FIG. 4, an insulating layer 40 may be arranged between the second portions 22 of the external electrodes 20. The insulating layer 40 further reduces the risk of dielectric breakdown between the second portions 22. Further, by providing the insulating layer 40 on the surface of the base body 10, the water absorption rate of the array-type inductor 1 can be reduced. The water absorption rate of the array-type inductor 1 according to this embodiment is preferably 2% or less, more preferably 1% or less.

The insulating layer 40 is preferably provided between the second portions 22 on the surface of the base body 10 on which the external electrode 20 is arranged, and is preferably provided over the entire area of the surface other than the portion on which the second portion 22 is arranged.

The insulating layer 40 may preferably be made of a material having a resistivity of 10⁸ Ω·cm or more, more preferably 10¹² Ω·cm or more. The material constituting the insulating layer 40 may be an organic material or an inorganic material. Specific examples include resins such as epoxy resin and polyimide resin, oxides such as SiO₂, ZnO, and Al₂O₃, glass and the like.

The thickness of the insulating layer 40 may preferably be 2 μm or more and 20 μm or less, more preferably 5 μm or more and 8 μm or less. When the thickness of the insulating layer 40 is 2 μm or more, the insulating effect can be enhanced, and when the thickness of the insulating layer 40 is 10 μm or less, the compact size of the array-type inductor 1 can be ensured. The thickness of the insulating layer 40 may be the same as that of the second portion 22. Thus, the thickness of the insulating layer 40 and the first portion 21 arranged outside the second portion 22 can be uniform.

### <Array-Type Inductor Built-In Substrate>

The array-type inductor 1 described above is preferably built into a substrate to be provided as a component-embedded substrate (also referred to as an array-type inductor-embedded substrate). FIG. 5 illustrates a schematic diagram of a component-embedded substrate 80 in which the array-type inductor 1 is embedded, as an example. In FIG. 5, the detailed configuration of the external electrodes 20 and 20′ of the array-type inductor 1 and the arrangement of the insulating layer 40 are omitted. The component-embedded substrate 80 can be formed by, for example, arranging the array-type inductor 1 in the through hole 81a formed in the substrate 81, sealing the array-type inductor 1 with resin, irradiating the external electrode 20 with laser to form a via hole, exposing the external electrode 20, and applying plating treatment to the via hole, thereby connecting the wiring 83 to the external electrode 20 of the array-type inductor 1, and then sealing the array-type inductor 1 with the sealing resin 82 on the first main surface 10a side and the second main surface 10b side.

Such a component-embedded substrate 80 has the advantage of being more compact than a wiring board of the component mounting type in which components are mounted on the main surface of the substrate, because elements can be arranged three-dimensionally including the thickness direction. However, because elements such as a CPU and components are arranged closer to each other, the space for wiring is reduced, so it is necessary to devise wiring with higher accuracy and less waste. In the array-type inductor 1 according to the present disclosure, because the inductor elements 5 can be densely arranged, the wiring between the inductor elements 5 can be shortened, and because the external electrode 20 can ensure a sufficient area, the degree of freedom of wiring is increased, and high-density wiring is possible. The array-type inductor 1 according to the present embodiment is less likely to cause dielectric breakdown.

### <Method of Manufacturing Array-Type Inductor>

The method of manufacturing array-type inductor according to the present disclosure is not particularly limited, and a known coil component manufacturing process such as a lamination process or a thin film process can be used. A method of manufacturing an array-type inductor by the lamination process will be described below as an example.

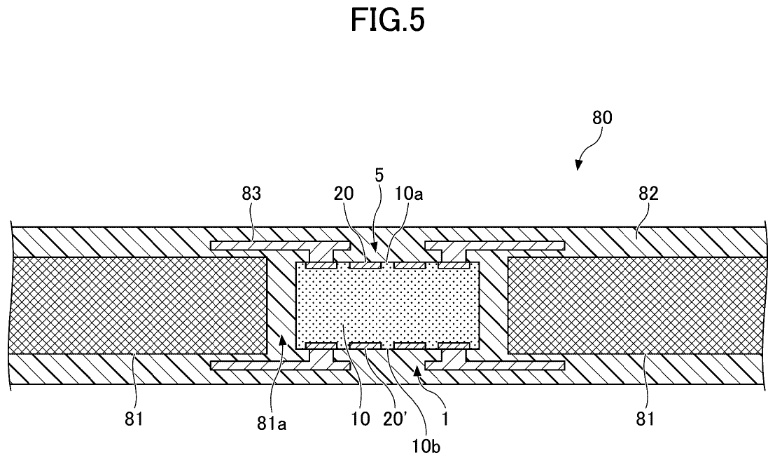

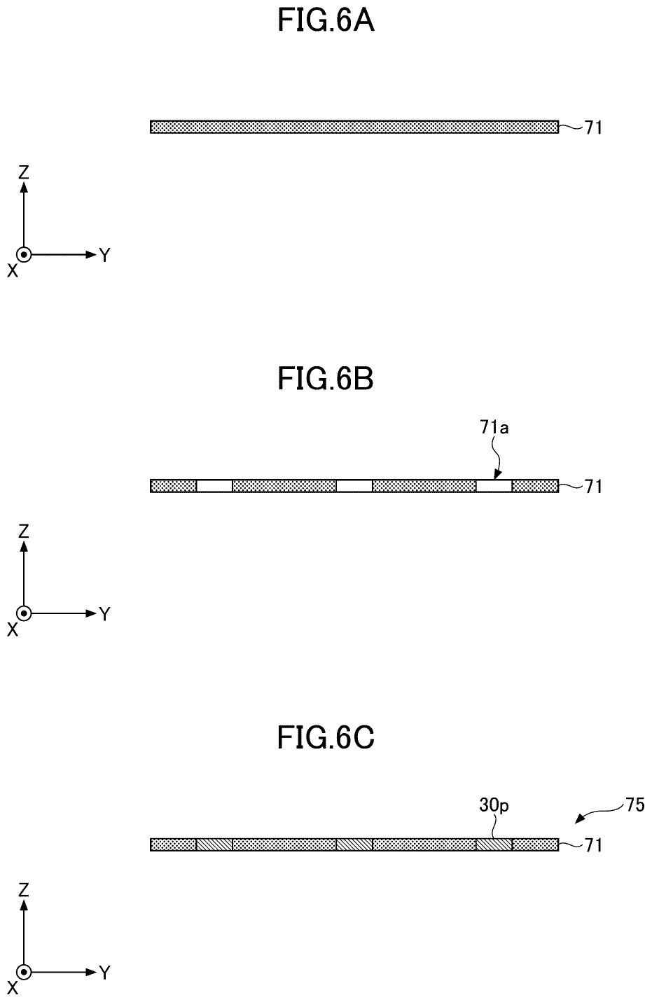

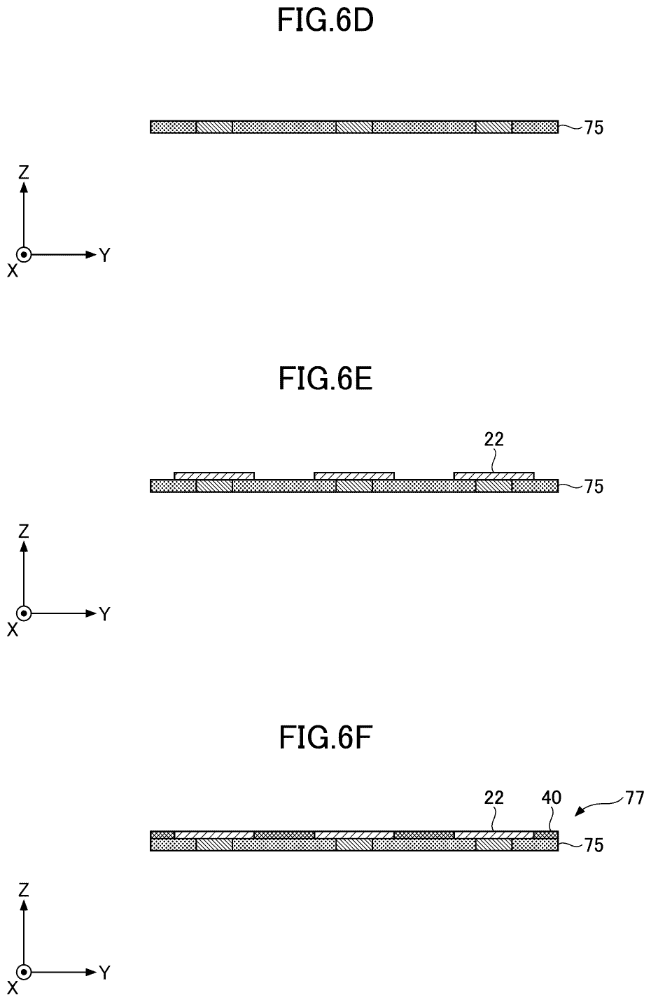

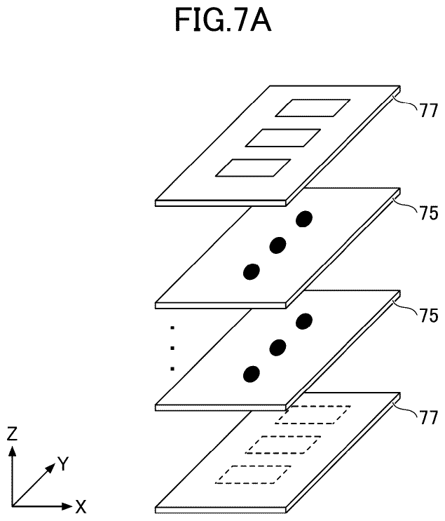

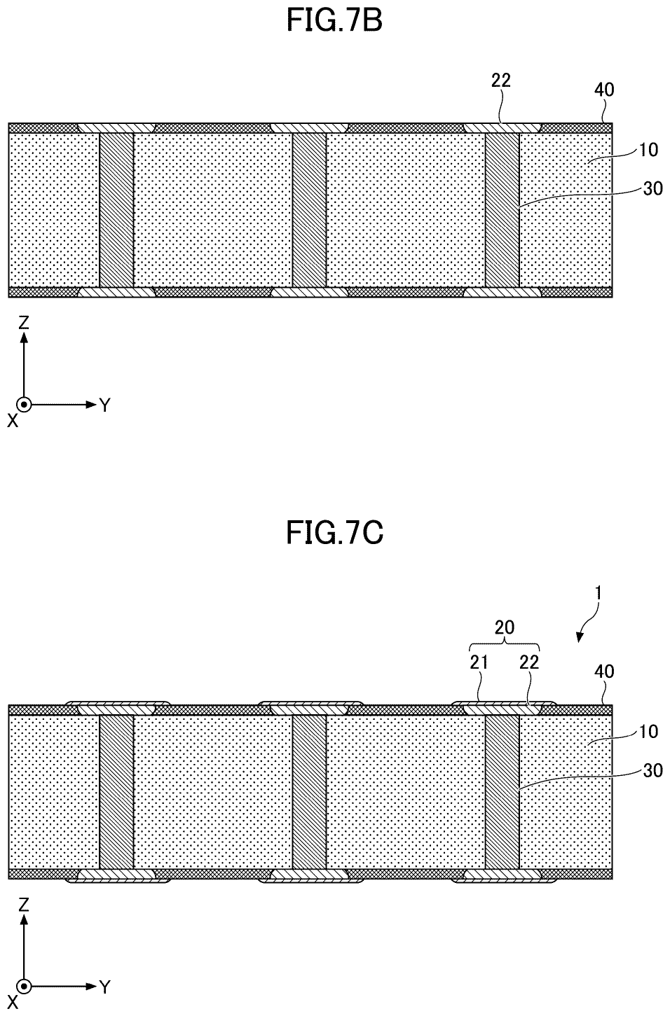

FIGS. 6A to 7C illustrate an example of a manufacturing method using the lamination process. First, a magnetic sheet 71 which is a precursor of the base body forming sheet constituting the base body 10 is produced (FIG. 6A). The magnetic sheet 71 is obtained by, for example, kneading a metallic magnetic material with a resin to produce a slurry, applying the slurry to a plastic base film by a method such as a doctor blade method, drying the slurry, and cutting the slurry into a predetermined size.

Next, a through hole 71a is formed at a predetermined position of the magnetic sheet 71 to penetrate in the thickness direction of the magnetic sheet 71 (FIG. 6B), and a conductive paste 30p is embedded in the through hole 71a formed in the magnetic sheet by printing the conductive paste on the upper surface of the magnetic sheet having the through hole 71a formed thereon by a method such as a screen printing method, thereby producing the body forming sheet 75 (FIG. 6C). When a plurality of the body forming sheets 75 are formed in this way, the size and position of the through hole 71a formed in the body forming sheet 75 can be the same. Further, the shape of the finally obtained conductor can be adjusted by changing the size, shape, or position of the through hole 71a.

On the other hand, as illustrated in FIGS. 6D to 6F, an outermost layer forming sheet 77 is prepared for forming a layer including the second portion 22 which becomes the inner portion of the external electrode 20. On the body forming sheet 75 (FIG. 6C) obtained in FIGS. 6A to 6C, the second portion 22 of the external electrode 20 is formed by screen printing or the like using conductive paste (FIG. 6E). Further, an insulating layer 40 is formed between the second portions 22 so as to be flush with the second portion 22 by screen printing or the like using insulating paste to form the outermost layer forming sheet 77 (FIG. 6F).

A plurality of the obtained body forming sheets 75 are laminated in the Z-direction of the array-type inductor 1 to be obtained, and the outermost layer forming sheets 77 are laminated on the uppermost and lowermost sides of the Z-direction, respectively (FIG. 7A). The obtained laminate may be thermally compressed by a press machine. Next, by using a cutting machine such as a dicing machine to dice the laminate to individual pieces of a desired size, the laminate diced into individual pieces is obtained. The laminate diced into individual pieces may be subjected to polishing treatment such as barrel polishing, if necessary.

Next, the laminate diced into individual pieces (FIG. 7B) is degreased and heated. By the heat treatment, an oxide layer is formed on each surface of the soft magnetic metal powder contained in the magnetic sheet, and adjacent soft magnetic metal powders are bonded through the oxide layer. The heat treatment of the chip laminate is carried out, for example, at a heating temperature of 600° C. to 800° C. for a heating time of 20 minutes to 120 minutes. Further, the first portion 21 of the external electrode 20 is formed by plating or the like to obtain the array-type inductor 1 (FIG. 7C).

Although the above-described lamination process is a method of laminating, in the Z-direction, the sheets having the main surfaces along the X-Y plane of the array-type inductor, it may be a process of laminating, in the X-direction, the sheets having the main surfaces along the Y-Z plane of the array-type inductor, or a process of laminating, in the Y-direction, the sheets having the main surfaces along the X-Z plane of the array-type inductor.

In the thin film process, a plurality of conductors are formed by, for example, plating, by using a conductor material, a positive resist obtained by developing a photoresist and then removing the positive resist. The plurality of conductors thus obtained are embedded in a base body material, and after undergoing dicing into individual pieces, degreasing, and heating treatment, external electrodes are formed by further plating treatment to obtain the array-type inductor.

Although specific embodiments have been described in detail above, the present disclosure is not limited to the above embodiments. The above embodiments can be changed, modified, replaced, added, deleted, combined, and the like in various ways within the scope of the claims.

Embodiments of the present disclosure are, for example, as follows.
<1> An array-type inductor including:
   a plurality of inductor elements provided in a base body made of a metallic magnetic material, wherein
   each of the plurality of inductor elements includes a conductor and an external electrode connected to the conductor,
   the external electrodes of the plurality of inductor elements are arranged on one surface of the base body so as to be separated from each other,
   each of the external electrodes has a first portion arranged on an outermost side thereof and a second portion connecting the first portion and the conductor,
   an insulating layer is arranged between the second portions,
   with respect to the inductor elements that are adjacent to each other, d1<d2<dc is satisfied, d1 denoting a distance between the first portions, d2 denoting a distance between the second portions, and dc denoting a distance between the conductors on the one surface.
<2> The array-type inductor according to <1>, wherein a value of a ratio of the distance d2 between the second portions to the distance d1 between the first portions is 10 or more and 20 or less.
<3> The array-type inductor according to <1> or <2>, wherein a value of a ratio of the distance de between the conductors to the distance d1 between the first portions is 2 or more.
<4> The array-type inductor according to any one of <1> to <3>, wherein in each of the plurality of inductor elements, the conductor is provided within confines of the first portion when viewed in a direction toward the one surface.
<5> The array-type inductor according to any one of <1> to <4>, wherein in each of the plurality of inductor elements, the conductor is provided within confines of the second portion when viewed in a direction toward the one surface.
<6> The array-type inductor according to any one of <1> to <5>, wherein in each of the plurality of inductor elements, the second portion is provided within confines of the first portion when viewed in a direction toward the one surface.

What is claimed is:

1. An array-type inductor comprising:
a plurality of inductor elements provided in a base body made of a metallic magnetic material, wherein
each of the plurality of inductor elements includes a conductor and an external electrode connected to the conductor,
the external electrodes of the plurality of inductor elements are arranged on one surface of the base body so as to be separated from each other,
each of the external electrodes has a first portion arranged on an outermost side thereof and a second portion connecting the first portion and the conductor,
an insulating layer is arranged between the second portions,
with respect to the inductor elements that are adjacent to each other, d1<d2<dc is satisfied, d1 denoting a distance between the first portions, d2 denoting a distance between the second portions, and dc denoting a distance between the conductors on the one surface.

2. The array-type inductor according to claim 1, wherein a value of a ratio of the distance d2 between the second portions to the distance d1 between the first portions is 10 or more and 20 or less.

3. The array-type inductor according to claim 1, wherein a value of a ratio of the distance dc between the conductors to the distance d1 between the first portions is 2 or more.

4. The array-type inductor according to claim 1, wherein in each of the plurality of inductor elements, the conductor is provided within confines of the first portion when viewed in a direction toward the one surface.

5. The array-type inductor according to claim 1, wherein in each of the plurality of inductor elements, the conductor is provided within confines of the second portion when viewed in a direction toward the one surface.

6. The array-type inductor according to claim 1, wherein in each of the plurality of inductor elements, the second portion is provided within confines of the first portion when viewed in a direction toward the one surface.

7. The array-type inductor according to claim 1, wherein the array-type inductor is a component embedded in a substrate.
